(19) United States
(12) Patent Application Publication
(10) Pub. No.: US 2008/0210902 A1
(43) Pub. Date: Sep. 4, 2008

(54) CRYSTALLINE NANOSTRUCTURED PARTICLES

(75) Inventors: Dan Coy, Naperville, IL (US); Harry Sarkas, Plainfield, IL (US); Robert Haines, Naperville, IL (US)

Correspondence Address: WILDMAN HARROLD ALLEN & DIXON LLP, 225 WEST WACKER DRIVE, SUITE 2800, CHICAGO, IL, 60606, US

(73) Assignee: NANOPHASE TECHNOLOGIES CORPORATION, Romeoville, IL (US)

(21) Appl. No.: 11/776,936

(22) Filed: Jul. 12, 2007

Related U.S. Application Data
(60) Provisional application No. 60/807,085, filed on Jul. 12, 2006.

(51) Int. Cl. C01F 17/00; C01G 9/02; C09K 3/00

(52) U.S. Cl. 252/182.33; 423/593.1; 428/402; 423/594.14; 423/594.9; 423/594.7; 423/263; 423/594.12

(57) ABSTRACT

Lattice doped stoichiometric-nanostructured materials having a plurality of discrete nanocrystalline particles, which are at least 95% crystalline, and a dopant either substituted in at least one nanocrystalline particle crystal lattice or interstitially located between crystal lattices or crystal planes of the nanocrystalline particles.

### CROSS-REFERENCE TO RELATED APPLICATIONS

This application claims priority to U.S. Provisional Patent Application No. 60/807,085, filed Jul. 12, 2006, which is hereby incorporated by reference.

### FIELD OF INVENTION

The present invention relates to discrete nanostructured material and applications of such nanostructured materials. In particular, the present invention is concerned generally with discrete nanostructured particles. More particularly, the invention is concerned with a variety of discrete, stoichiometric-nanostructured particles manufactured in plasma arc systems disclosed in U.S. Pat. Nos. 5,460,701, 5,514,349, and 6,669,823, and 5,874,684, which are hereby incorporated by reference.

### BACKGROUND

Nanostructured particles have unique properties that result from their small particle size—such as high surface area, high reactivity per mass, and volume confinement effects. The shortcomings of the existing art—the inability to control dopant location within the crystal lattice, the nature of interstitial dopant stabilization, and dopant reactivity—are overcome and additional advantages are provided through the manufacture of discrete primary, nanostructured particles rather than particle aggregates which have secondary structure. As described in more detail below, the full benefit of the nanostructured particles can be obtained from discrete lattice doped particles comprising at least about 95% crystallinity and employing application methodologies which enable this discrete nanostructure to be maintained in application. The degree of crystallinity may be determined through X-ray diffraction. In general the crystal structure of the matrix becomes distorted by the presence of the dopant; at higher dopant levels the crystal distortion becomes so great that a different matrix crystal phase is observed.

Methods of nanoparticle formation by plasma techniques are previously known in the art and teach that materials formed by plasma techniques may have unusual properties. However, the prior art does not teach the synthesis of discrete, stoichiometric-nanostructured particles that are at least 95% crystalline, are lattice doped, and that provide application benefits. As used herein, lattice doped stoichiometric-nanostructured materials are defined as materials manufactured by plasma techniques having controlled chemistry at the angstrom, or sub-nano, scale where the dopant may be substituted in the crystal lattice or may be interstitially located between crystal lattices or crystal planes. The chemistry of the nanostructured material may be completely controlled in the chemical sense with respect to a reactant and may have one or more dopant atoms incorporated in the lattice to provide application benefit.

### SUMMARY

In one example, a lattice doped stoichiometric-nanostructured material has a plurality of discrete nanocrystalline particles, wherein the nanocrystalline particles are at least 95% crystalline, and a dopant substituted in at least one nanocrystalline particle crystal lattice.

In another example, a lattice doped stoichiometric-nanostructured material has a plurality of discrete nanocrystalline particles, wherein the nanocrystalline particles are at least 95% crystalline, and a dopant interstitially located between crystal lattices or crystal planes of the nanocrystalline particles.

### DETAILED DESCRIPTION

Discrete, lattice doped stoichiometric-nanostructured materials have dopants substituted either in the crystal lattice or interstitially located between crystal lattices or crystal planes. Although the chemistry of the nanostructured material is controlled in the chemical sense, the application utility and benefit of the doped stoichiometric-nanostructured materials is controlled by the location of the dopant. For example, dopants located in the crystal lattice are substituted for chemically-like atoms (e.g. Al substituted for Zn in a ZnO lattice) and control the lattice properties such as: electromagnetic absorption, emission, and scattering; electrical conductivity; dielectric constant; etc. Dopants located interstitially between crystal lattices or crystal planes may influence the crystal matrix in manners similar to lattice-substituted dopants, but to a lesser degree. Dopants located interstitially may also be considered stabilized-atomic additives with may easily react with the environment of the doped stoichiometric-nanostructured material—for example, in aqueous solution the dopant may be easily dissolved from the nanoparticle or reacted with environmental reactants.

In one example, nanostructured materials comprise discrete primary nanocrystalline particles having size of about 1-100 nm and an average size less than about 60 nm. In addition, the nanocrystalline particles could have an average size between about 10 nm and 50 nm, and more particularly between about 20 nm and 40 nm. In addition, the primary particles may have a substantially spherical shape (i.e. are equi-axed) and are formed within a plasma. The nanostructured particles may be at least 95% and up to about 100% crystalline and lattice doped at the atomic scale.

In one particular example, the lattice doped stoichiometric-nanostructured materials comprise metal oxide nanocrystalline particles doped with different metal(s) depending on the desired physical properties. Examples include, but are not limited to, ZnO doped with either Ag or Al. The dopant may either replace Zn in the ZnO lattice or be located interstitially between ZnO crystal planes, in a fashion controlled by processing conditions. The dopant level can range from the ppb level to 50% atomic substitution—the preferred, or optimal dopant level depends on the specific material need to enable an application.

Various application methodologies can be used to prepare stable dispersions of the discrete, nanostructured particles in either aqueous or organic media using techniques disclosed in U.S. patent application Ser. Nos. 10/357,941 and 10/174,955, which are hereby incorporated by reference.

The stable dispersions of the discrete, nanostructured particles in either aqueous or organic media can be used to deliver the nanostructured particles in application. Examples include, but are not limited to, wipe-on cleaners with and without anti-microbial properties, surface conditioners, or surface modifiers in a single fluid or formulation. The delivery of discrete nanostructured particles to a surface ensures a denser, more uniform coverage of nanoparticles compared with materials which have a secondary structure. The lattice doped stoichiometric-nanostructured materials afford the greatest degree of coverage, or a relatively small inter-particle distance, for a given particle size and dispersion (formulation) content.

The stable dispersions of non-aggregated, discrete, nanostructured particles in either aqueous or organic media can also be incorporated into a formulated article or coating which contains the non-aggregated, discrete nanostructured particles in application. Examples include, but are not limited to, paints, coatings, inks, polymers, plastics, overprint varnishes, closure compounds, varnishes, and sealants. The discrete nanostructured particles may be delivered uniformly throughout the permanent formulated article or coating, or may be uniformly concentrated at an interface or bulk by judicious formulation additives or processing. The application derives the greatest benefit from the discrete, nanostructured particles in this fashion because a secondary structure is absent and a relatively small inter-particle distance is achieved, for a given particle size and dispersion (formulation) content.

In some applications, the present invention can provide application benefits where the dopant interacts with the crystal matrix to provide synergistic application benefit. Examples include, but are not limited to:

Al and Ag dopants in ZnO crystal to form semiconductors;

Sb dopants in SnO₂ crystal to form conductors;

Ag dopants in ZnO crystal to form anti-microbial agents; and

Zr dopant in CeO₂ crystal to form a more thermally stable oxygen-storage catalyst.

In other applications, the present invention can provide application benefits where more than one dopant type interacts with the crystal matrix to provide multiple synergistic application benefits. Examples include, but are not limited to:

Ag and Cu dopants in ZnO crystal to form anti-microbial agents;

Zr and La in CeO₂ crystal to form a more thermally stable oxygen-storage catalyst with improved low temperature performance; and

Zr and Pr in CeO₂ crystal to form a more thermally stable oxygen-storage catalyst with improved low temperature performance.

### EXAMPLES

The following examples are not meant to be limiting, but are illustrative and may be compositionally extended for many applications by one of ordinary skill in the art.

For examples 1-3 below, discrete, doped ZnO or doped SnO₂ of >95% crystallinity was manufactured by plasma methods disclosed in U.S. Pat. Nos. 5,460,701, 5,514,349, and 6,669,823 using predominantly nitrogen plasmas, which provide the reactants that stabilize interstitial dopants.

For examples 4-6 below, discrete, doped CeO₂ of >95% crystallinity was manufactured by “active” plasma methods disclosed in U.S. Pat. No. 6,669,823 using approximately 70:30 to 90:10 Ar:O₂ plasmas.

### Example 1

Al was atomically doped into a ZnO lattice at atomic substitution levels of 0.01% to 10%.

### Example 2

Ag and Ag/Cu mixtures were atomically doped interstitially in a ZnO lattice at atomic substitution levels of 0.05% to 5%.

### Example 3

Sb was atomically doped into a SnO₂ lattice per Example 1 at atomic substitution levels of approximately 5%.

### Example 4

Zr was atomically doped into a CeO₂ lattice at atomic substitution levels of 0.1% to 55%.

### Example 5

Zr and Pr were atomically doped into a CeO₂ lattice at atomic substitution levels of 0.1% to 30% and 0.1% to 20%, respectively.

### Example 6

Zr and La were atomically doped into a CeO₂ lattice at atomic substitution levels of 0.1% to 30% and 0.1% to 20%, respectively.

### Example 7

Anti-microbial efficacy was measured by a time kill assay—a water dispersion containing the nanoparticle of interest is inoculated with a known amount of a specific organism. At preset exposure times, the dispersion is sampled and the organism population is measured. A 5 log reduction in organism population is considered a complete kill—the organism population is correlated with exposure time.

Discrete ZnO nanoparticles of >95% crystallinity and approximately 40-nm in size have preservative anti-microbial properties. However, discrete, 0.2% Ag-interstitially lattice doped ZnO particles of >95% crystallinity and approximately 40-nm in size have surprisingly enhanced antimicrobial properties as shown in the following table. The effective Ag concentration is 5 ppm—anti-microbial efficacy at this extremely low concentration is a result of interstitial doping and has high commercial value.

| | | Pseudomonas aeruginosa | Staphylococcus aureus |
|---|---|---|---|
| | | (gram − bacteria) | (gram + bacteria) |
| ZnO | 0.25 wt % | 4.97 log/24 hr | 5+ log/24 hr |
| ZnO:Ag | 0.25 wt % | 3.60 log/1 hr | 5.3 log/1 hr |

The third and forth columns refer to time required to get near 5 log kill—the data is expressed in kill/time.

### Example 8

Discrete, lattice doped nanostructured ZnO particles are semiconductors and have demonstrated active performance in printed field effect transistors. Undoped ZnO nanoparticles have Zn interstitials and perform as an n-doped material. Al-lattice doping creates nanostructured ZnO particles with greater n-type character and creates n+ degenerate material. Ag-lattice doping creates nanostructured ZnO particles with less n-type character.

### Example 9

The following terms are used in this example and have the meanings set forth below unless it is stated otherwise:

BET specific surface area—the surface area determined by the Brunauer, Emmett, and Teller method for determining specific surface area by nitrogen adsorption. The theory is described in Adamson, Arthur W., “Physical Chemistry of Surfaces,” ch. 13 entitled “Adsorption of Gases and Vapors on Solids,” pp. 584-589, published by Interscience Publishers (1967), which is hereby incorporated by reference. Unless stated otherwise, all references to the surface area of the catalyst, core, particles or cerium oxide refer to the BET surface area.

Oxygen storage capacity (OSC)—the ability of the oxygen storage material to absorb oxygen in an oxidative atmosphere and desorb oxygen in a substantially inert atmosphere. In this invention, the OSC was quantified on a Hi-Res TGA 2950 Thermogravimetric Analyzer, available from TA Instruments, New Castle, Del., which measures the weight of the oxygen storage material as a function of temperature after the oxygen storage material is subjected to sequential oxidation-reduction cycles. Each oxidation-reduction cycle involves (a) heating the test material to 600° C. under oxygen at 10° C. per minute to fully oxidize the material, (b) reducing the material with a hydrogen-nitrogen gas (2%/98%, mole basis) for 15 to 45 minutes at 600° C., and (c) oxidizing the material with oxygen for 10 to 30 minutes at 600° C. The OSC of the material, expressed as moles of oxygen per gram of catalyst, is then calculated as follows:

OSC=[mass under oxygen−mass under hydrogen-nitrogen]/[32×mass of oxygen storage material]

Sintering—the agglomeration of particles when heated at temperatures below their melting point. Agglomeration implies that within a particle cluster, individual particles have coalesced to form an aggregate that has increased strength and a concomitant decrease in net particle surface area.

Discrete, lattice doped nanostructured CeO₂ particles are catalysts and have demonstrated active performance as oxygen-storage catalysts. Undoped CeO₂ nanoparticles have a catalytic activity, measured in μmoles O₂/g material or OSC, of 85 and 27 at 600° C. and 500° C., respectively. However if CeO₂ is heated to 1050° C. it sinters, particles become larger (lower BET), and OSC drops form 85 to 13 at 600° C. Zr-doping at 35% nanostructures CeO₂ yielding greater OSC and rendering more thermal stable and increases OSC at 600° C. to 300 and 250 before and after heating to 1050° C. However, true value is created by adding Pr- or La-dopants to Zr-doped CeO₂ to significantly increase OSC properties at 500° C. for all thermal treatments as shown in the table below.

| | | | Catalytic Activity | |
|---|---|---|---|---|
| | | BET | μmoles O₂/g | |
| | Calcination | m²/g | 500° C. | 600° C. |
| ceria (9-nm) | None | 90 | 27 | 85 |
| | 800° C. | 47 | 35 | 74 |
| | 1050° C. | 5 | | 13 |
| doped ceria | None | 85 | 13 | 300 |
| CeₓZr_{y}O₂ (65:35) | 1050° C. | 21 | | 240 |
| CeₓZr_{y}La_{z}O₂ (72:20:8) | None | 69 | | 238 |
| | 800° C. | 56 | 87 | 130 |
| | 900° C. | 49 | 80 | 166 |
| | 1050° C. | 27 | | 170 |
| CeₓZr_{y}Pr_{z}O₂ (73:20:7) | None | 78 | | 229 |
| | 800° C. | 64 | 97 | 191 |
| | 900° C. | 52 | 87 | 164 |
| | 1050° C. | 24 | | 174 |

It will be apparent to those skilled in the art that various modifications and variations can be made in the dopant and bulk materials, compositions, and methods of the invention without departing from the spirit or scope of the invention including post-treatment doped chemistries to further enable an application. In a similar fashion, examples of applications include, but are not limited to—electronics (conductors, semiconductors, dielectrics, and magnetic materials); anti-microbial agents (sterilizers, disinfectants, sanitizers, preservatives); catalysts, additives for paints, coatings, polymers, and plastics; chemical transformation agents; and biomedical applications. It is therefore intended that the present invention covers the modifications and variations of this invention, and applications of this invention, provided they come within the scope of the appended claims and their equivalents.

The foregoing description of the preferred embodiment of the invention has been presented for purposes of illustration and description, and is not intended to be exhaustive or to limit the invention to the precise form disclosed. The descriptions were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

What is claimed is:

1. A lattice doped stoichiometric-nanostructured material, comprising:
a plurality of discrete nanocrystalline particles, wherein the nanocrystalline particles are at least 95% crystalline; and
a dopant substituted in at least one nanocrystalline particle crystal lattice.

2. The lattice doped stoichiometric-nanostructured material of claim 1, wherein the nanocrystalline particles are substantially spherical nanocrystalline particles.

3. The lattice doped stoichiometric-nanostructured material of claim 1, wherein the nanocrystalline particles comprise at least one metal or metal oxide.

4. The lattice doped stoichiometric-nanostructured material of claim 3, wherein the nanocrystalline particles comprise ZnO.

5. The lattice doped stoichiometric-nanostructured material of claim 4, wherein the dopant comprises Al.

6. The lattice doped stoichiometric-nanostructured material of claim 4, wherein the dopant comprises Ag.

7. The lattice doped stoichiometric-nanostructured material of claim 4, wherein the dopant comprises Ag and Cu.

8. The lattice doped stoichiometric-nanostructured material of claim 3, wherein the nanocrystalline particles comprise SnO₂.

9. The lattice doped stoichiometric-nanostructured material of claim 8, wherein the dopant comprises Sb.

10. The lattice doped stoichiometric-nanostructured material of claim 3, wherein the nanocrystalline particles comprise CeO₂.

11. The lattice doped stoichiometric-nanostructured material of claim 10, wherein the dopant comprises Zr.

12. The lattice doped stoichiometric-nanostructured material of claim 11, wherein the dopant further comprises La.

13. The lattice doped stoichiometric-nanostructured material of claim 11, wherein the dopant further comprises Pr.

14. The lattice doped stoichiometric-nanostructured material of claim 1, wherein the nanocrystalline particles comprise metals and metal oxides.

15. The lattice doped stoichiometric-nanostructured material of claim 1, wherein the nanocrystalline particles comprise a combination of oxides.

16. The lattice doped stoichiometric-nanostructured material of claim 1, wherein the nanocrystalline particles have a size of about 1 nm to 100 nm and an average size less than about 60 nm.

17. The lattice doped stoichiometric-nanostructured material of claim 1, wherein the nanocrystalline particles have a size of about 10 nm to 50 nm.

18. The lattice doped stoichiometric-nanostructured material of claim 17, wherein the nanocrystalline particles have a size of about 20 nm to 40 nm.

19. The lattice doped stoichiometric-nanostructured material of claim 1, wherein the plurality of particles has a dopant level which can range from about 0.1 ppb level to 50% atomic substitution.

20. The lattice doped stoichiometric-nanostructured material of claim 1, wherein the nanocrystalline particles are dispersed as non-aggregating nanocrystalline particles in at least one of an aqueous or organic media.

21. A lattice doped stoichiometric-nanostructured material, comprising:
a plurality of discrete nanocrystalline particles, wherein the nanocrystalline particles are at least 95% crystalline; and
a stabilized dopant interstitially located between crystal lattices or crystal planes of the nanocrystalline particles.

22. The lattice doped stoichiometric-nanostructured material of claim 21, wherein the nanocrystalline particles are substantially spherical nanocrystalline particles.

23. The lattice doped stoichiometric-nanostructured material of claim 21, wherein the nanocrystalline particles comprise at least one metal or metal oxide.

24. The lattice doped stoichiometric-nanostructured material of claim 23, wherein the nanocrystalline particles comprise ZnO.

25. The lattice doped stoichiometric-nanostructured material of claim 24, wherein the dopant comprises Al.

26. The lattice doped stoichiometric-nanostructured material of claim 24, wherein the dopant comprises Ag.

27. The lattice doped stoichiometric-nanostructured material of claim 24, wherein the dopant comprises Ag and Cu.

28. The lattice doped stoichiometric-nanostructured material of claim 23, wherein the nanocrystalline particles comprise SnO₂.

29. The lattice doped stoichiometric-nanostructured material of claim 28, wherein the dopant comprises Sb.

30. The lattice doped stoichiometric-nanostructured material of claim 23, wherein the nanocrystalline particles comprise CeO₂.

31. The lattice doped stoichiometric-nanostructured material of claim 30, wherein the dopant comprises Zr.

32. The lattice doped stoichiometric-nanostructured material of claim 31, wherein the dopant further comprises La.

33. The lattice doped stoichiometric-nanostructured material of claim 31, wherein the dopant further comprises Pr.

34. The lattice doped stoichiometric-nanostructured material of claim 21, wherein the nanocrystalline particles comprise metals and metal oxides.

35. The lattice doped stoichiometric-nanostructured material of claim 21, wherein the nanocrystalline particles comprise a combination of oxides.

36. The lattice doped stoichiometric-nanostructured material of claim 21, wherein the nanocrystalline particles have a size of about 1 nm to 100 nm and an average size less than about 60 nm.

37. The lattice doped stoichiometric-nanostructured material of claim 21, wherein the nanocrystalline particles have a size of about 10 nm to 50 nm.

38. The lattice doped stoichiometric-nanostructured material of claim 37, wherein the nanocrystalline particles have a size of about 20 nm to 40 nm.

39. The lattice doped stoichiometric-nanostructured material of claim 21, wherein the plurality of particles has a dopant level which can range from about 0.1 ppb level to 50% atomic composition.

40. The lattice doped stoichiometric-nanostructured material of claim 21, wherein the nanocrystalline particles are dispersed as non-aggregated nanocrystalline particles in at least one of an aqueous or organic media.
